(19) United States
(12) Patent Application Publication
(10) Pub. No.: US 2020/0297463 A1
(43) Pub. Date: Sep. 24, 2020

(54) IMPLANTABLE ABUTMENTS, ABUTMENT SYSTEMS, AND METHODS OF OPERATION THEREOF

(71) Applicant: JET Dental, Inc., Provo, UT (US)

(72) Inventor: Ole JENSEN, Englewood, CO (US)

(73) Assignee: JET Dental, Inc., Provo, UT (US)

(21) Appl. No.: 16/358,430

(22) Filed: Mar. 19, 2019

(51) Int. Cl. A61C 8/00

(52) U.S. Cl. CPC A61C 8/0063; A61C 8/0056; A61C 8/0022

(57) ABSTRACT

Improved devices, systems, and methods for securing a dental prosthesis within an oral cavity of a subject are disclosed. In one embodiment, an implant system comprises an implantable abutment comprising a threaded fixation portion and an abutment portion. At least part of the threaded fixation portion can be configured to be implanted within the alveolar bone or alveolar process of the subject and at least part of the abutment portion can be configured to protrude beyond the gingiva of the subject. The system can also comprise a sleeve comprising a sleeve frame and a plurality of locking tabs configured to lock the sleeve to the abutment portion and lock a dental coping to the abutment portion. The threaded fixation portion can be defined by an exterior tubular profile and wherein the abutment portion can be set within the exterior tubular profile.

### TECHNICAL FIELD

The present disclosure relates generally to apparatus for retaining one or more dental prostheses in an oral cavity of a user and, more specifically, to improved implantable abutments, abutment systems, and methods of operation thereof.

### BACKGROUND

The use of dental prostheses to replace missing or damaged teeth is commonplace. Typically, artificial roots or hollow screw-type implants are implanted into the jawbone of the patient and are used to provide structural support to a separate abutment piece that acts as an intermediary between the implant and the artificial teeth or crown. The artificial teeth or crown is often fastened to the abutment typically by screws, adhesives, or a combination thereof.

FIGS. 1A to 1D illustrate partial cross-sectional side views of one example of a traditional implant procedure with a crown being secured within a mouth of a patient. Depending upon the number of teeth to be replaced, one or more holes can be drilled into the patient's alveolar bone or alveolar process. As shown in FIG. 1A, a portion of the patient's gums or gingiva 14 can be cut open to expose the underlying bone 10 into which a drill bit 16 can be used to bore open a hole 12. An anchoring implant 18 (for example, a hollow threaded screw) can be implanted within the hole 12 and covered by the gingiva 14 or gums of the patient to allow for healing and for the implant 18 to take hold within the bone 10, as shown in FIG. 1B.

Once the implant 18 has been desirably positioned within the bone 10, an abutment 20 can be securely attached to the implant 18, for example, by a threaded pin 22 coupling to an implant receiving well 24 defined within the implant 18 as shown in FIG. 1C. With the abutment 20 secured to the implant 18, an oral appliance 26 or dental prosthesis, such as a crown, can be secured upon the abutment 20 by utilizing a number of securement mechanisms, such as cement or a fastener such as a screw. Other securement mechanisms can include interference fittings, magnets, or a combination thereof.

Because the implant, abutment, and oral appliance are subjected to high compressive and shear forces, proper attachment of the oral appliance is an important step of the implantation procedure. While cement or other adhesives are commonly used to attach the oral appliance to the abutment, such adhesives provide little tolerance for mistakes once the adhesive has set because of the difficulty and expense in removing a cemented oral appliance from the abutment. In addition, dental professionals often apply too much cement to the area surrounding the abutment. Such excess cement has been shown in studies to be associated with high rates of peri-implant disease in patients receiving certain oral appliances. See Wilson, Thomas G. The positive relationship between excess cement and peri-implant disease: a prospective clinical endoscopic study. Journal of Periodontology 2009: 80: 1388-1392. Moreover, the interface between the implant and the abutment (such as any holes or cavities for receiving screws or other type of fasteners) can attract bacteria and result in infection.

Accordingly, there exists a need for devices and systems which can improve the implantation procedure but also allow for the removal and/or repositioning of the dental prosthesis without causing unnecessary damage to the dental prosthesis. In addition, such devices and systems should also reduce the complexity of traditional dental implant systems and be cost-effective to manufacture.

### SUMMARY

Improved devices, systems, and methods for securing a dental prosthesis within an oral cavity of a subject are disclosed. In one embodiment, an implant system comprises an implantable abutment comprising a threaded fixation portion and an abutment portion. At least part of the threaded fixation portion can be configured to be implanted within the alveolar bone or alveolar process of the subject. Moreover, at least part of the abutment portion can be configured to protrude beyond the gingiva of the subject. In some embodiments, at least part of the threaded fixation portion and the abutment portion can protrude out of the gingiva of the subject when the implantable abutment is implanted within the alveolar bone or alveolar process of the subject.

In one embodiment, the dental prosthesis can be a dental crown. In other embodiments, the dental prosthesis can be at least part of a bridge, partial overdenture, or a complete overdenture.

The system can also comprise a sleeve comprising a sleeve frame and a plurality of locking tabs. The sleeve can be configured to fit over at least a portion of the abutment portion.

A subset of the plurality of locking tabs can be configured to project radially inward relative to the sleeve frame to secure the sleeve to the abutment portion.

The system can also comprise a coping comprising a coping exterior surface configured to be adhered to the dental prosthesis. The coping can be configured to be placed over the sleeve when the sleeve is secured to the abutment portion. Another subset of the plurality of locking tabs can be configured to project radially outward relative to the sleeve frame to secure the coping to the sleeve.

The threaded fixation portion can be defined by an exterior tubular profile (e.g., a substantially cylindrical exterior tubular profile). In some embodiments, the abutment portion can be set within the exterior tubular profile such that no part of the abutment portion exceeds a lateral boundary of the exterior tubular profile.

The abutment portion can be angled with respect to a longitudinal axis of the threaded fixation portion. In some embodiments, the abutment portion can be angled with respect to the longitudinal axis of the threaded fixation portion at an angle of about 13 degrees. In other embodiments, the abutment portion can be angled with respect to the longitudinal axis of the threaded fixation portion at an angle of about 26 degrees.

The system can also comprise an insertion cap configured to be placed over the abutment portion as part of the implantation or installation procedure. The insertion cap can further comprise a tool coupling feature for detachably engaging with a rotatable drive tool used to apply torque to the implantable abutment. In some embodiments, the insertion cap can detachably engage with at least a portion of the threaded fixation portion.

A method of securing a dental prosthesis within an oral cavity of a subject is also disclosed. The method can comprise securing an implantable abutment within an oral cavity of a subject. The implantable abutment can comprise a threaded fixation portion and an abutment portion. At least part of the threaded fixation portion can be implanted within the alveolar bone or alveolar process of the subject and at least part of the abutment portion can extend beyond the gingiva of the subject.

The method can also comprise introducing a sleeve comprising a plurality of locking tabs on to a part of the abutment portion. A subset of the plurality of locking tabs can project radially inward relative to the sleeve frame to secure the sleeve to the abutment portion. The method can also comprise introducing a coping comprising a coping surface configured to be adhered to the dental prosthesis on to a part of the sleeve when the sleeve is secured to the abutment portion.

The method can also comprise capping the abutment portion with an insertion cap as part of an implantation or installation procedure. The method can further comprise applying torque to the implantable abutment using a rotatable drive tool configured to detachably engage with a tool coupling feature of the insertion cap. The insertion cap can detachably engage with at least a portion of the threaded fixation portion.

### BRIEF DESCRIPTION OF THE DRAWINGS

FIGS. 1A to 1D illustrate partial cross-sectional profiles of a traditional implant procedure.

FIG. 2 illustrates an exploded view of an embodiment of a system for adjustably retaining a dental prosthesis.

FIG. 3A illustrates an abutment portion of an implantable abutment fitting within an exterior tubular profile of the threaded fixation portion of the implantable abutment.

FIG. 3B illustrates a sleeve and abutment portion of an implantable abutment fitting within an exterior tubular profile of the threaded fixation portion of the implantable abutment.

FIG. 4A illustrates an angled abutment portion of an embodiment of an implantable abutment fitting within an exterior tubular profile of the threaded fixation portion of the implantable abutment.

FIG. 4B illustrates an angled abutment portion of another embodiment of an implantable abutment fitting within an exterior tubular profile of the threaded fixation portion of the implantable abutment.

FIG. 5A illustrates an embodiment of an abutment portion of the implantable abutment comprising a polygonal projection.

FIG. 5B illustrates a top plan view of the abutment portion comprising the polygonal projection.

FIG. 5C illustrates an embodiment of an abutment portion of the implantable abutment comprising a polygonal recess.

FIG. 6A illustrates an embodiment of an insertion cap configured to be placed over the abutment portion of the implantable abutment.

FIG. 6B illustrates a cross-sectional side view of the insertion cap being placed over the abutment portion of the implantable abutment.

FIG. 6C illustrates a cross-sectional side view of another embodiment of the insertion cap.

FIG. 6D illustrates an insertion cap being placed over an embodiment of the implantable abutment having an angled abutment portion.

FIG. 6E illustrates another embodiment of the insertion cap having a threaded engagement portion.

FIGS. 7A to 7D illustrate different thread patterns of the threaded fixation portion of the implantable abutment.

FIGS. 8A to 8D illustrate variations of the sleeve in a splayed configuration.

FIGS. 9A to 9B illustrate steps of a method for securing a dental prosthesis within an oral cavity of a subject using components of the system disclosed herein.

FIG. 10 illustrates a cross-sectional side view of a variation of a coping covering the sleeve secured to the abutment portion of the implantable abutment.

FIGS. 11A to 11C illustrate steps of a method for removing the dental prosthesis from the implantable abutment.

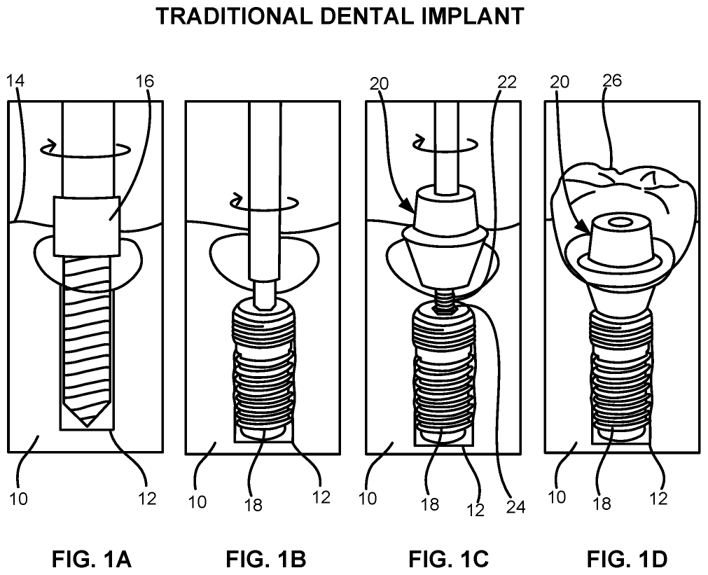

### DETAILED DESCRIPTION

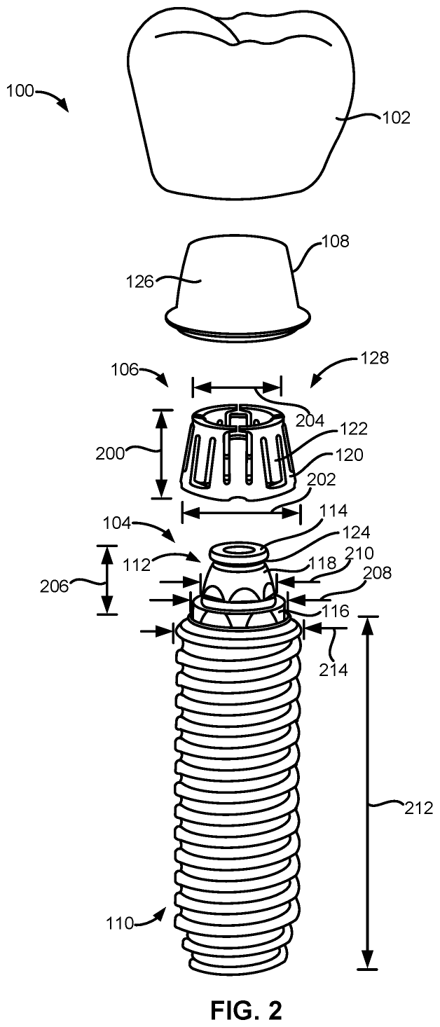

FIG. 2 illustrates an exploded view of an embodiment of a system 100 for adjustably retaining a dental prosthesis 102. The system 100 can comprise an implantable abutment 104 and a securement sleeve 106 configured to be secured to the implantable abutment 104. The sleeve 106 can be adjustably secured such that the sleeve 106 can be decoupled or separated from the implantable abutment 104 (and secured again). The system 100 can also comprise a coping 108 configured to be adjustably secured to the securement sleeve 106. The dental prosthesis 102 can be affixed to the coping 108 via adhesives, cement, an interference fit, or a combination thereof.

The implantable abutment 104 can comprise a threaded fixation portion 110 and an abutment portion 112. The abutment portion 112 can comprise an abutment top 114, an abutment base 116, and a substantially conical frustum 118 disposed in between the abutment top 114 and the abutment base 116.

At least part of the threaded fixation portion 110 can be configured to be implanted within the alveolar bone or alveolar process of the subject when the system 100 is used to retain the dental prosthesis 102 within the oral cavity of the subject. In some embodiments, the threaded fixation portion 110 can be implanted within or coupled to a pre-existing portion of a subject's dentition, such as to a part of a root or pulp chamber of the subject.

Moreover, at least part of the abutment portion 112 (e.g., the abutment top 114 and at least part or all of the abutment base 116 and the frustum 118) can be configured to protrude beyond the gingiva or gum tissue of the subject when the threaded fixation portion 110 is implanted within the oral cavity. The system 100 and system components disclosed herein can be utilized in any number of locations within the oral cavity of the subject including, for example, along the maxilla or mandible of the subject. In addition, while a singular instance of the implantable abutment 104 is shown in the figures, it is contemplated by this disclosure that one subject can have multiple instances of the implantable abutment 104 implanted within the oral cavity of the subject.

The abutment portion 112 can be directly connected to or integrated with the threaded fixation portion 110. The abutment portion 112 can be directly connected to or integrated with the threaded fixation portion 110 without an intervening fastener. For example, the abutment portion 112 can be directly connected to or integrated with the threaded fixation portion 110 by being a shaped or formed end of the threaded fixation portion 110 (e.g., a shaped or formed end of a threaded screw). In other embodiments, the abutment portion 112 can be affixed, attached, or otherwise fixedly coupled to the threaded fixation portion 110. In these embodiments, the abutment portion 112 can be affixed, attached, or otherwise fixedly coupled to the threaded fixation portion 110 without an intervening screw or fastener. When the abutment portion 112 is connected, integrated with, or fixedly coupled to the threaded fixation portion 110, the implantable abutment 104 can be considered a one-piece implantable abutment.

One advantage of the abutment portion 112 being directly connected to or integrated with the threaded fixation portion 110 is that the abutment portion 112 is less susceptible to bacterial infection over time. Moreover, the entire implant system 100 requires less components and the complexity of the entire implant procedure is reduced.

The securement sleeve 106 can comprise a sleeve frame 120 and a plurality of locking tabs 122 or flaps. The plurality of locking tabs 122 can extend longitudinally along a lateral surface of the sleeve 106. The securement sleeve 106 can be configured to fit over or on the frustum 118 of the abutment portion 112. For example, the securement sleeve 106 can circumferentially surround the frustum 118 when the sleeve 106 is fitted over or placed on the frustum 118. As will be discussed in more detail in the following sections, a subset of the plurality of locking tabs 122 can be configured to project radially inward relative to the sleeve frame 120 to secure the sleeve 106 to the abutment portion 112. The sleeve 106 can be secured to the abutment portion 112 when at least one of the plurality of locking tabs 122 physically contacts or lodges against an abutment undercut 124 defined in between the frustum 118 and the abutment top 114.

The implantable abutment 104 can be fabricated from or be made in part of a number of biocompatible materials. For example, the implantable abutment 104 can be fabricated from or be made in part of titanium or titanium alloys, gold or gold alloys, stainless steel, nickel-titanium alloys, nickel-chromium alloys, cobalt-chromium alloys, or a combination thereof. The abutment portion 112 can be sized and/or shaped to accommodate the securement sleeve 106. The abutment portion 112 or parts thereof can comprise features disclosed in U.S. Pat. No. 9,855,120, which is herein incorporated by reference in its entireties.

The coping 108 can be a cap or covering serving as a platform or accommodating base for the dental prosthesis 102. The coping 108 can be configured to be placed over the sleeve 106 when the sleeve 106 is secured to the abutment portion 112. For example, the interior surface of the coping 108 can be shaped or defined to fit over or onto the abutment portion 112 or a combination of the abutment portion 112 and the sleeve 106 secured to the abutment portion 112. In the variation shown in FIG. 2, the coping 108 can be shaped substantially as a thimble or frustoconic having rounded edges. In other embodiments, the coping 108 can be shaped substantially as a cylinder, a conic, or a polyhedron. The dental prosthesis 102 can be affixed, attached, or otherwise coupled to a coping exterior surface 126. The dental prosthesis 102 can be affixed or otherwise coupled to the coping exterior surface 126 by a biocompatible adhesive or luting agent such as resin cements, glass-ionomer (GI) cements, resin-modified glass-ionomer cements (RMGICs), zinc phosphate luting agents, zinc polycarboxylate luting agents, or a combination thereof. The coping exterior surface 126 can be a smooth or unabraded surface or an etched or abraded surface.

As will be discussed in more detail in the following sections, a subset of the plurality of locking tabs 122 can be configured to project radially outward relative to the sleeve frame 120 to secure the coping 108 to the sleeve 106. The sleeve 106 can secure the coping 108 to the sleeve 106 when the sleeve 106 is secured to the abutment portion 112 of the implantable abutment 104.

Although not shown in the figures, the system 100 can also comprise a seal or gasket configured to be placed in between the coping 108 and at least one of the abutment base 116 and a top surface of the threaded fixation portion 110. The seal can serve as a cushioning layer or interface between the coping 108 and the abutment base 116 or the top of the threaded fixation portion 110. The seal can be fabricated from or be made in part of any number of biocompatible materials or biocompatible elastomers such as silicone, polyurethane, rubber or other thermoplastic elastomers (TPEs), or a combination thereof.

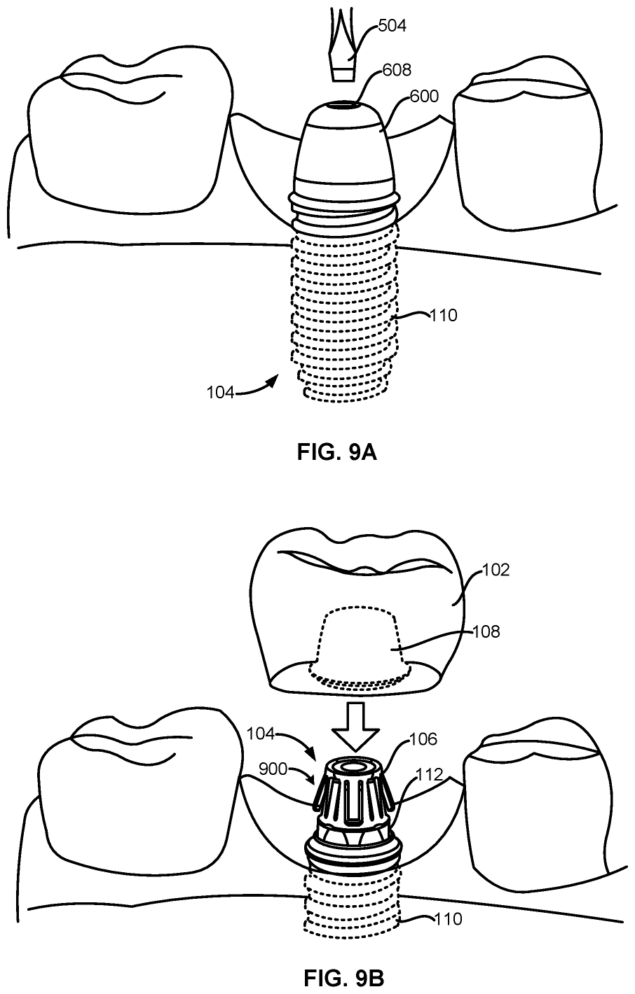

FIG. 2 also illustrates that the securement sleeve 106 can have a low-profile configuration 128. The low-profile configuration 128 can be a formation or arrangement of the securement sleeve 106 when the locking tabs 122 are straightened or flush with respect to a lateral surface of the sleeve frame 120. The securement sleeve 106 can also be considered to be in the low-profile configuration 128 when the locking tabs 122 do not project radially inward or radially outward relative to the lateral surface of the sleeve frame 120. In other variations, the securement sleeve 106 can be considered to be in the low-profile configuration 128 when the locking tabs 122 project less radially inward or outward relative to the lateral surface of the sleeve frame 120 than the securement sleeve 106 in a locking configuration 900 (see FIG. 9C).

Moreover, FIG. 2 illustrates that the sleeve can have a sleeve height dimension 200, a base sleeve diameter 202, and a top sleeve diameter 204. The sleeve height dimension 200 can be a height of the securement sleeve 106 as measured from the base of the sleeve 106 to the top of the sleeve 106 when the sleeve 106 is in a tapered or substantially frustoconical (i.e., truncated conical) configuration. The sleeve height dimension 200 can range from about 2.0 mm to about 6.0 mm. More specifically, the sleeve height dimension 200 can range from about 2.5 mm to about 5.0 mm.

The base sleeve diameter 202 can be a diameter of the securement sleeve 106 as measured at the base of the sleeve 106 (e.g., at the base of the frustoconical-shaped sleeve). The base sleeve diameter 202 can range from about 2.0 mm to about 4.8 mm. More specifically, the base sleeve diameter 202 can range from about 3.0 mm to about 4.5 mm.

The top sleeve diameter 204 can be a diameter of the securement sleeve 106 as measured at the top of the sleeve 106 (e.g., at the top of the frustoconical shaped sleeve). The top sleeve diameter 204 can range from about 0.5 mm to about 4.0 mm. More specifically, the top sleeve diameter 204 can range from about 2.5 mm to about 3.5 mm.

For example, one variation of the securement sleeve 106 can have a sleeve height dimension 200 of about 2.5 mm, a base sleeve diameter 202 of about 3.8 mm, and a top sleeve diameter 204 of about 3.0 mm. In some instances, this variation of the securement sleeve 106 can be used to secure a dental prosthesis 102 configured to replace a bicuspid, a cuspid, or an incisor.

Another variation of the securement sleeve 106 can have a sleeve height dimension 200 of about 3.5 mm, a base sleeve diameter 202 of about 4.5 mm, and a top sleeve diameter 204 of about 4.0 mm. In some instances, this variation of the securement sleeve 106 can be used to secure a dental prosthesis 102 configured to replace a molar.

In some embodiments, the dental prosthesis 102 can be a crown. In other embodiments, the dental prosthesis 102 can be at least part of a bridge, a partial overdenture, or a complete overdenture. In additional embodiments, the dental prosthesis 102 can be any type of oral appliance or tooth analogue for replacing the natural dentition of the subject.

FIG. 2 also illustrates that the abutment portion 112 can have an abutment height 206, an abutment base diameter 208, and a maximum frustum diameter 210. The abutment height 206 can be a height dimension measured from the abutment base 116 to the abutment top 114. The abutment height 206 can range from about 2.0 mm to about 8.0 mm. More specifically, the abutment height 206 can range from about 3.0 mm to about 6.0 mm (e.g., about 3.5 mm or about 4.0 mm).

The abutment base diameter 208 can be a maximum diameter as measured at the abutment base 116. The abutment base diameter 208 can range from about 3.0 mm to about 5.5 mm. The maximum frustum diameter 210 can be a diameter of the frustum 118 as measured at the widest part of the frustum 118. The maximum frustum diameter 210 can range from about 3.0 mm to about 5.0 mm.

The threaded fixation portion 110 can have a fixation portion height 212 and a fixation portion diameter 214. The fixation portion height 212 can be measured from a distal end of the threaded fixation portion 110 (e.g., a distal or terminal screw end) to the top of the threaded fixation portion 110 or the abutment base 116. The fixation portion height 212 can range from about 5.0 mm to about 11.0 mm. More specifically, the fixation portion height 212 can range from about 6.0 mm to about 10.0 mm. The fixation portion diameter 214 can be a diameter of the threaded fixation portion 110 as measured at the widest part of the threaded fixation portion 110 (e.g., a maximum screw diameter). The fixation portion diameter 214 can range from about 4.0 mm to about 6.0 mm. The fixation portion diameter 214 can be equal to or greater than the abutment base diameter 208 and the maximum frustum diameter 210.

The securement sleeve 106 can be fabricated from or be made in part of a shape memory material such as a shape memory metal or metal alloy, a shape memory polymer, or a composite thereof. In these and other variations, the securement sleeve 106 can be fabricated from or comprise stainless steel, nickel-titanium alloys such as Nitinol, titanium, or a composite thereof.

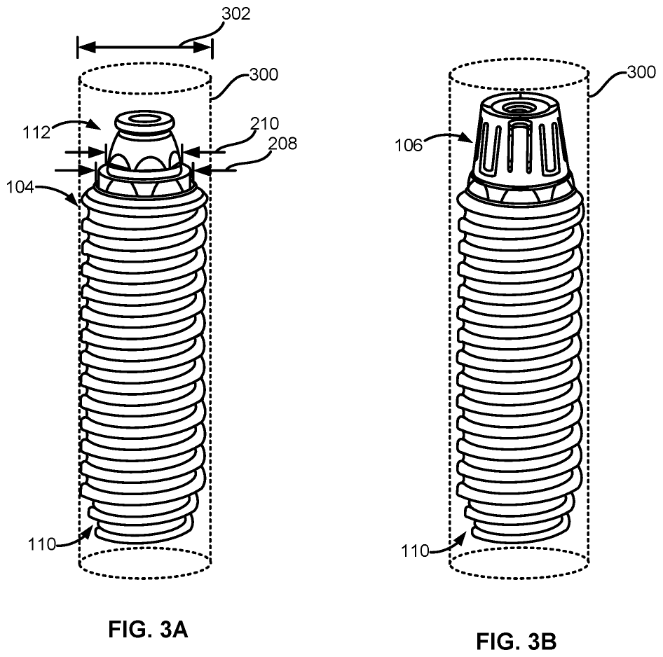

FIG. 3A illustrates that the threaded fixation portion 110 can be defined by an exterior tubular profile 300. The exterior tubular profile 300 can be used to delineate or demarcate an exterior contour or outline of the threaded fixation portion 110. The exterior tubular profile 300 can be a substantially cylindrical profile. The exterior tubular profile 300 can circumferentially adjoin or contact the exterior surface of the threaded fixation portion 110.

The exterior tubular profile 300 can have a profile diameter 302. In some embodiments, the profile diameter 302 can be the same or substantially equivalent to the fixation portion diameter 214. In other embodiments, the profile diameter 302 can be slightly larger (e.g., between about 0.01 mm to about 0.5 mm larger) than the fixation portion diameter 214.

As shown in FIG. 3A, the entirety of the abutment portion 112 can be positioned within or otherwise encompassed by the exterior tubular profile 300 when the exterior tubular profile 300 is longitudinally elongated or drawn out to extend past the abutment portion 112. The entirety of the abutment portion 112 can be circumscribed by the exterior tubular profile 300 when the exterior tubular profile 300 is longitudinally elongated or drawn out to extend past the abutment portion 112. In certain embodiments, the abutment portion 112 is sized and configured such that no part of the abutment portion 112 extends past or extends beyond the exterior tubular profile 300 of the threaded fixation portion 110 (i.e., no part of the abutment portion exceeds a lateral boundary of the exterior tubular profile 300).

The profile diameter 302 can be greater than or equal to the abutment base diameter 208. The profile diameter 302 can also be greater than the maximum frustum diameter 210.

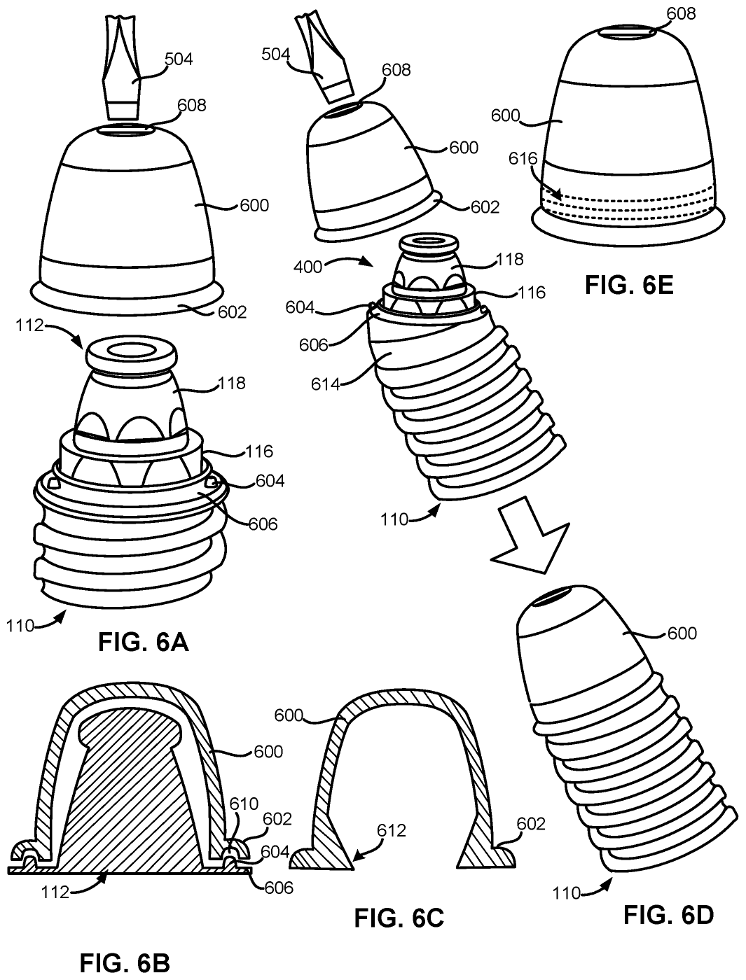

One advantage conferred by this design is that the implantable abutment 104 is easier to manufacture as a single-piece. Moreover, as will be discussed in more detail in the following sections, an insertion cap 600 (see FIGS. 6A-6E) can be placed over the abutment portion 112 and the implantable abutment 104 can be rotated via the insertion cap 600.

FIG. 3B illustrates that the entirety of the securement sleeve 106 can be positioned or otherwise encompassed by the exterior tubular profile 300 when the sleeve 106 is placed on the frustum 118 of the abutment portion 112. In some embodiments, the entirety of the securement sleeve 106, including the plurality of locking tabs 122, can be positioned or otherwise encompassed by the exterior tubular profile 300 when the sleeve 106 is placed on the frustum 118 of the abutment portion 112 in the locking configuration 900 (see FIG. 9C). In other embodiments, a segment of at least one of the locking tabs 122 can extend past at least part of the exterior tubular profile 300 when the sleeve 106 is in the locking configuration 900.

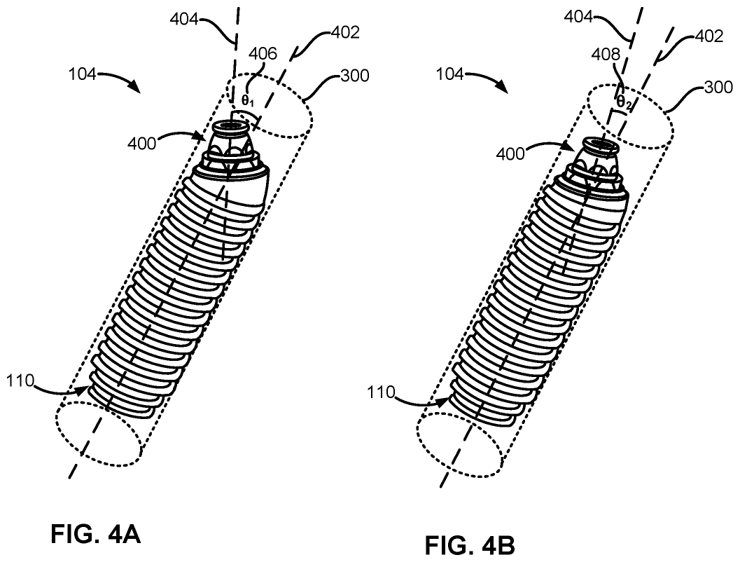

FIGS. 4A and 4B illustrate that the implantable abutment 104 can comprise an angled abutment portion 400. The angled abutment portion 400 can be angled with respect to a thread longitudinal axis 402 extending through the length of the threaded fixation portion 110. More specifically, a frustum 118 of the angled abutment portion 400 can have a frustum longitudinal axis 404 extending through the length of the frustum 118. The frustum longitudinal axis 404 can be angled with respect to the thread longitudinal axis 402. The angled abutment portion 400 can be fabricated from the same material(s) as the abutment portion 112 shown in FIGS. 2, 3A and 3B.

As illustrated in FIG. 4A, the frustum longitudinal axis 404 can be angled with respect to the thread longitudinal axis 402 at a first angle 406 (θ₁). In one example embodiment, the first angle 406 (θ₁) can be about 26 degrees. In other embodiments, the first angle 406 (θ₁) can be between about 22 degrees to about 26 degrees. In additional embodiments, the first angle 406 (θ₁) can be between about 26 degrees to about 30 degrees.

As illustrated in FIG. 4B, the frustum longitudinal axis 404 can be angled with respect to the thread longitudinal axis 402 at a second angle 408 (θ₂). In one example embodiment, the second angle 408 (θ₂) can be about 13 degrees. In other embodiments, the second angle 408 (θ₂) can be between about 9 degrees to about 13 degrees. In other embodiments, the second angle 408 (θ₂) can be between about 13 degrees to about 17 degrees (e.g., about 15 degrees).

Implantable abutments 104 comprising the angled abutment portions 400 disclosed herein are advantageous over other angled abutment assemblies. More specifically, a one-piece implantable abutment 104 comprising an angled abutment portion 400 angled with respect to the threaded fixation portion 110 at either the first angle 406 or the second angle 408 can accommodate most types of dental prostheses and can be implanted with relative ease at various locations within the oral cavity of the subject. Moreover, the angled abutment portion 400 disclosed herein (defined by either the first angle 406 or the second angle 408) can accommodate an insertion cap 600 (see FIGS. 6A-6E) to apply torque to the implantable abutment 104 to rotate the implantable abutment 104 in connection with an implantation or installation procedure.

As shown in FIGS. 4A and 4B, the entirety of the angled abutment portion 400 can be positioned within or otherwise encompassed by the exterior tubular profile 300 when the exterior tubular profile 300 is longitudinally elongated or drawn out to extend past the angled abutment portion 400. For example, the entirety of the angled abutment portion 400 can also be circumscribed by the exterior tubular profile 300 when the exterior tubular profile 300 is longitudinally elongated or drawn out to extend past the angled abutment portion 400. The angled abutment portion 400 can be sized and configured such that no part of the angled abutment portion 400 extends past or extends beyond the lateral boundary of the exterior tubular profile 300 of the threaded fixation portion 110.

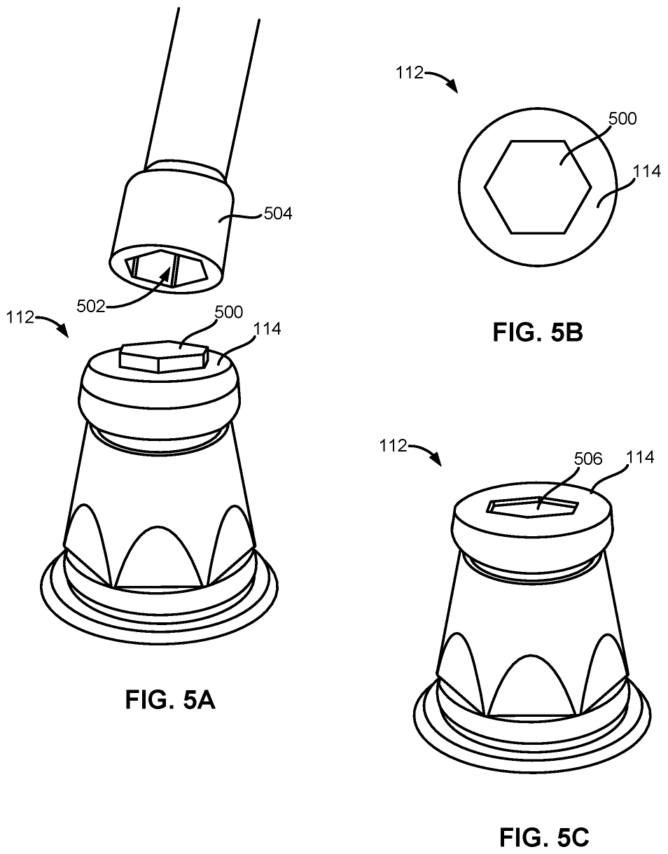

FIG. 5A illustrates an embodiment of an abutment portion 112 of the implantable abutment 104 comprising a polygonal projection 500. For example, as depicted in FIG. 5A, the polygonal projection 500 can be a hexagonal projection. The polygonal projection 500 can extend from or be positioned on the abutment top 114 of the abutment portion 112. In other embodiments contemplated by this disclosure, the polygonal projection 500 can be a triangular projection, a square projection, a pentagonal projection, an octagonal projection, or a star polygon projection. The polygonal projection 500 can be any raised polygon shape capable of fitting within a tool cavity 502 of a drive tool 504 configured to rotate or transmit torque to the implantable abutment 104. The polygonal projection 500 can be keyed to the tool cavity 502 such that the polygonal projection 500 fits tightly within at least a portion of the tool cavity 502.

The drive tool 504 can rotate the implantable abutment 104 when the implantable abutment 104 is being installed, positioned, or otherwise implanted within a bore hole made in the alveolar bone or alveolar process of the subject.

In some embodiments, the drive tool 504 can be a wrench, a part of a dental drill, or any other device for transmitting torque to the abutment portion 112. When the drive tool 504 comprises a tool cavity 502 at a distal end of the drive tool 504, the drive tool 504 can be considered an insertion tool having a female connector or interface (e.g., a female torque wrench or female drill bit).

FIG. 5B illustrates a top plan view of the abutment portion 112 comprising the polygonal projection 500. FIG. 5B illustrates that the polygonal projection 500 can be substantially centered on the abutment top 114. The polygonal projection 500 can be sized to accommodate different sized tool cavities 502 and sized based on the area of the abutment top 114.

Although FIGS. 5A and 5B illustrate the abutment portion 112 as having a polygonal projection 500 protruding out of the abutment top 114, it is contemplated by this disclosure that the abutment portion 112 can also comprise a receiving cavity 506 (e.g., a polygonal receiving cavity 506) as illustrated in FIG. 5C.

The receiving cavity 506 can be any sunken or recessed shapes or slots defined along the abutment top 114. For example, as shown in FIG. 5C, the receiving cavity 506 can be a polygonal receiving cavity such as a hexagonal receiving cavity. In other embodiments, the receiving cavity 506 can be a triangular receiving cavity or recess, a square receiving cavity or recess, a pentagonal receiving cavity or recess, an octagonal receiving cavity or recess, or a star polygon receiving cavity or recess. In these embodiments, the drive tool 504 can comprise a projection rather than a tool cavity 502 at a distal end of the drive tool 504. The projection can be keyed or paired with the shape of the polygonal receiving cavity 506. When the drive tool 504 comprises a tool projection at the distal end of the drive tool 504, the drive tool 504 can be considered an insertion tool having a male connector or interface (e.g., a male torque wrench or male drill bit). In some embodiments, the drive tool 504 can be a dental screwdriver bit (see, for example, FIG. 6A).

FIG. 6A illustrates an insertion cap 600 configured to be placed over the abutment portion 112 of the implantable abutment 104. The insertion cap 600 can completely cover the abutment portion 112 when the insertion cap 600 is placed over the abutment portion 112. In other embodiments, the insertion cap 600 can partially cover the abutment portion 112 when the insertion cap 600 is placed over the abutment portion 112. The insertion cap 600 can be used to transmit torque to the implantable abutment 104 as the implantable abutment 104 is being installed or implanted within the alveolar bone or alveolar process of the subject. The insertion cap 600 can be included as part of the dental implant system disclosed herein.

The insertion cap 600 can comprise a cap brim 602 or a cap base. The cap brim 602 can extend radially outward beyond a lateral surface (e.g., the tapered surface) of the insertion cap 600. As will be discussed in more detail in the following sections, one or more features defined along the cap brim 602 or the cap base can engage with one or more catches or protuberances 604 extending or rising out of a rim portion 606 of the threaded fixation portion 110.

The insertion cap 600 can also comprise a tool coupling feature 608 for detachably engaging with a rotatable drive tool 504. The rotatable drive tool 504 can be used to apply torque to rotate the implantable abutment 104 during the implantation or installation procedure.

In some embodiments, the tool coupling feature 608 can be a receiving cavity (e.g., a polygonal receiving cavity) or a slot for receiving a rotatable drive tool 504 having a male connector or interface positioned at a distal end of the rotatable drive tool 504 (e.g., a screwdriver bit or blade tip, a polygonal projection, etc.). In other embodiments, the tool coupling feature 608 can be a projection such as a polygonal projection for detachably engaging with a tool cavity defined at a distal end of the rotatable drive tool 504.

FIG. 6B illustrates that one or more depressions 610 or recesses defined along an underside of the cap brim 602 or the cap base can fit tightly over the one or more protuberances 604 extending out of the rim portion 606 of the threaded fixation portion 110. In other embodiments contemplated by this disclosure, the protuberances 604 can extend out of or be defined along a rimmed surface of the abutment base 116.

In some embodiments, the protuberances 604 can be dome-shaped, hemispherical, cuboid, partially-ovoid, frustoconical, or a combination thereof. The depression 610 or recess defined along the underside of the cap brim 602 or cap base can correspond to or accommodate the shape or size of the protuberance 604. For example, the depression 610 or recess can also be dome-shaped, hemispherical, cuboid, partially-ovoid, or frustoconical. The protuberances 604 can key into the depressions 610 or recesses to temporarily engage the insertion cap 600 with the abutment portion 112. Once engaged, a rotatable drive tool 504 can be used to rotate the implantable abutment 104.

Although FIGS. 6A and 6B show the implantable abutment 104 having two protuberances 604, it is contemplated by this disclosure that the implantable abutment 104 can comprise three, four, five, six, seven, or eight or more protuberances 604.

Moreover, although FIGS. 6A and 6B illustrate the protuberances 604 defined along the rim portion 606 of the threaded fixation portion 110, it is contemplated by this disclosure that the protuberances 604 can be affixed or extend out of an underside of the cap brim 602 of the insertion cap 600. In this embodiment, the rim portion 606 of the threaded fixation portion 110 can be defined by a number of recesses or depressions similar to the depressions 610 defined along the cap brim 602 in FIG. 6B. The protuberances 604 extending from the insertion cap 600 can key into the depressions or recesses defined along the rim portion 606 of the threaded fixation portion 110 or a rim surface along the abutment base 116. In all such embodiments, the insertion cap 600 can be used to temporarily engage with or interlock with the implantable abutment 104 so that torque can be transmitted to the implantable abutment 104 using a drive tool 504.

FIG. 6C illustrates a cross-sectional side view of another embodiment of the insertion cap 600. In this embodiment, the insertion cap 600 can comprise a narrow cap opening 612 or a constricted interior portion. The insertion cap 600 having the narrow cap opening 612 or the constricted interior portion can engage with the abutment portion 112, the top of the threaded fixation portion 110, or a combination thereof by seizing or clasping onto a segment or portion of the implantable abutment 104 when the insertion cap 600 is pushed or otherwise forcibly biased on to the implantable abutment 104. For example, the narrow cap opening 612 or the constricted interior portion of the insertion cap 600 can seize or clasp onto a top portion of the threaded fixation portion 110, the abutment base 116, or a transition portion 614 (see FIG. 6D) in between the threaded fixation portion 110 and the abutment base 116.

As will be discussed in more detail in the following sections, in some embodiments, at least part of the threaded fixation portion 110 and the abutment portion 112 can protrude out of the gingiva of the subject when the implantable abutment 104 is securely implanted or installed within the alveolar bone or alveolar process of the subject. This allows the insertion cap 600 to seize or clasp onto at least a portion of the threaded fixation portion 110 in proximity to the abutment portion 112. When the embodiment of the insertion cap 600 shown in FIG. 6C is placed over or onto the abutment portion 112, a rotatable drive tool 504 can be used to apply torque to the implantable abutment 104 via the insertion cap 600.

FIG. 6D illustrates an insertion cap 600 being placed over an embodiment of the implantable abutment 104 having an angled abutment portion 400 (e.g., having an angle of about 13 degrees or 26 degrees as shown in FIGS. 4A and 4B). In some instances, the implantable abutment 104 having the angled abutment portion 400 can be used when part of the subject's jawbone directly underneath the tooth to be replaced is damaged or diseased. In other instances, the implantable abutment 104 having the angled abutment portion 400 can be used to support crowns or other oral prosthesis designed to replace incisor teeth such as one or more lateral incisors or central incisors. In certain circumstances, implants having angled abutments can be preferred over implants having non-angled abutments in order to properly align the oral prosthesis with the subject's adjacent dentition.

As illustrated in FIG. 6D, the insertion cap 600 can completely cover the angled abutment portion 400. A drive tool 504 (e.g., a wrench, a screwdriver, a drill, or portions thereof) can then be used to apply torque to the implantable abutment 104 having the angled abutment portion 400 once the insertion cap 600 is placed over or on top of the angled abutment portion 400. For example, depressions 610 or recesses defined along the cap brim 602 or the cap base can engage or interlock with protuberances 604 defined along the rim portion 606 of the threaded fixation portion 110 or a rim surface of the abutment base 116. In some embodiments, the protuberances 604 can be tilted or angled with respect to a longitudinal axis extending through the threaded fixation portion 110. In other embodiments, the protuberances 604 can extend parallel to a longitudinal axis extending through the threaded fixation portion 110. Moreover, in alternative embodiments not shown in the figures but contemplated by this disclosure, the insertion cap 600 can have protuberances 604 extending out from under the cap brim 602 or from the cap base to engage with depressions or recesses defined along the rim portion 606 or the abutment base 116.

FIG. 6E illustrates another embodiment of the insertion cap 600 having a threaded engagement portion 616. The threaded engagement portion 616 can refer to a thread pattern or threaded surface defined circumferentially within the interior of the insertion cap 600. In this embodiment, the insertion cap 600 can be screwed on to a top portion of the threaded fixation portion 110. Once the insertion cap 600 is screwed on to at least part of the threaded fixation portion 110, a rotatable drive tool 504 can be used to apply torque to the entire assembly comprising the insertion cap 600 and the implantable abutment 104. Once the implantable abutment 104 is secured within the alveolar bone or alveolar process of the subject, the insertion cap 600 can be rotated in the opposite rotational direction to remove the insertion cap 600 from the implantable abutment 104.

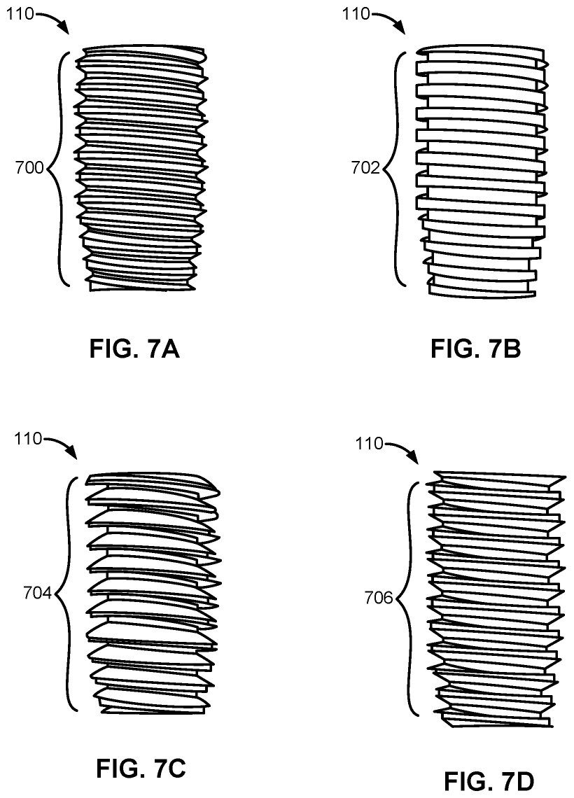

FIGS. 7A-7D illustrate that the threaded fixation portion 110 can be defined by different thread patterns or forms. As illustrated in FIG. 7A, the threaded fixation portion 110 can be defined by a V-shaped thread pattern 700 having substantially symmetrical sides inclined at substantially equivalent angles.

FIG. 7B illustrates that the threaded fixation portion 110 can also be defined by a square-shaped thread pattern 702 having symmetrical sides substantially perpendicular to the thread longitudinal axis 402. Moreover, FIGS. 7C and 7D illustrate that the threaded fixation portion 110 can further be defined by a buttress-thread pattern 704 or a reverse buttress-thread pattern 704, respectively. Screws or implants comprising the buttress-thread pattern 704 or the reverse buttress-thread pattern 704 can have non-symmetrical sides and can sometimes be more stable upon implantation than screws or implants having the V-shaped thread pattern 700 or the square-shaped thread pattern 702.

The threaded fixation portion 110 can be fabricated from or be made in part of titanium or titanium alloys. For example, the threaded fixation portion 110 can be fabricated from or be made in part of grade 1, 2, or 4 titanium or another dental-grade titanium. More specifically, the threaded fixation portion can be fabricated from or be made in part of Ti6Al4V titanium alloy (e.g., 6% Al and 4% Va), titanium zirconium alloy (such as TiZr1317, e.g., titanium zirconium alloy with 13%-17% zirconium).

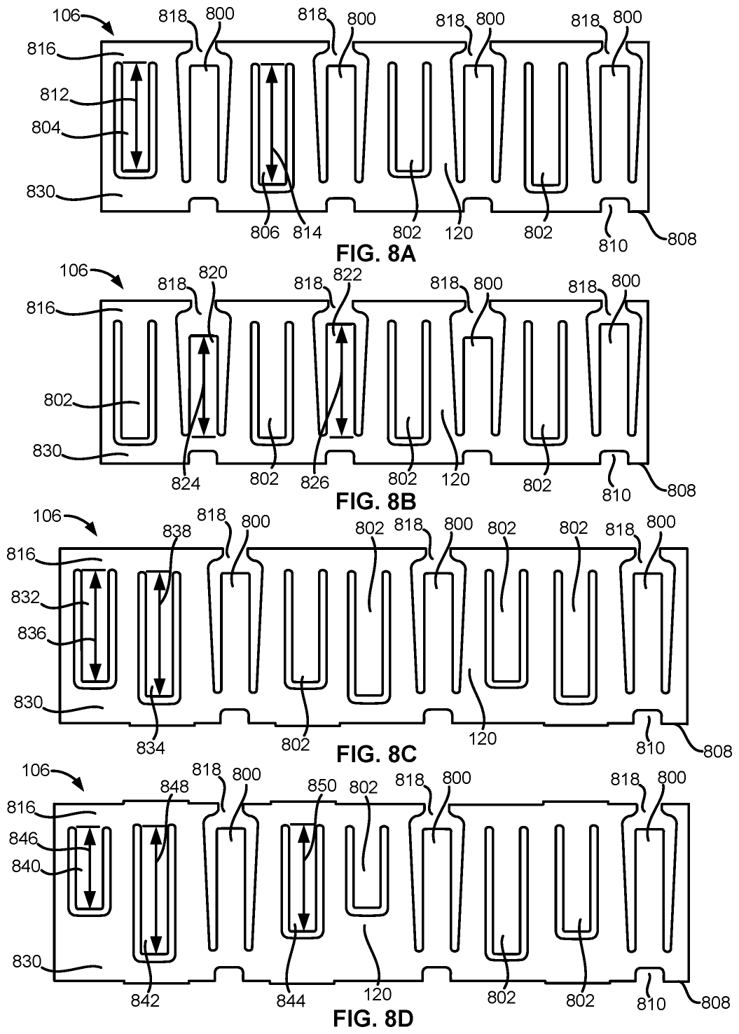

FIGS. 8A to 8D illustrate variations of the securement sleeve 106 in a splayed or flattened configuration. As shown in FIGS. 8A to 8D, the locking tabs 122 can have differing length dimensions. FIG. 8A illustrates that a variation of the securement sleeve 106 can have eight total locking tabs 122 with four inward tabs 800 and four outward tabs 802. The locking tabs 122 can be arranged in an alternating manner with each inward tab 800 adjacent to two outward tabs 802 and each outward tab 802 adjacent to two inward tabs 800. FIG. 8A also illustrates that the outward tabs 802 can include a first outward tab 804 and a second outward tab 806. The first outward tab 804 can be separated from the second outward tab 806 by an inward tab 800.

Additionally, the sleeve frame 120 can have a bottom edge 808. The bottom edge 808 can be defined by one or more cutouts 810 along the bottom edge 808. The cutouts 810 can be shaped substantially as half or partial-circles, half or partial-ovals, rectangles, triangles, trapezoids, or a combination thereof. The cutouts 810 or grooves can allow the sleeve 106 to more easily fold or curl into the tapered shape (see, e.g., FIGS. 2, 3B, 9B, and 11C) a cylindrical shape, or any other shape.

The first outward tab 804 can have a first length dimension 812 and the second outward tab 806 can have a second length dimension 814. The first length dimension 812 can be a longitudinal length of the first outward tab 804. The first length dimension 812 can be measured from the base of the first outward tab 804 to the tip or terminal end of the first outward tab 804. The base of the first outward tab 804 can be the portion of the first outward tab 804 connected to an upper portion 816 of the sleeve frame 120.

The second length dimension 814 can be a longitudinal length of the second outward tab 806. The second length dimension 814 can be measured from the base of the second outward tab 806 to the tip or terminal end of the second outward tab 806. The base of the second outward tab 806 can be the portion of the second outward tab 806 connected to the upper portion 816 of the sleeve frame 120.

The second length dimension 814 can be greater than the first length dimension 812. The difference between the second length dimension 814 and the first length dimension 812 can be between about 0.10 mm and about 2.0 mm. Also, for example, the difference between the second length dimension 814 and the first length dimension 812 can be between about 0.01 mm and about 0.10 mm. FIG. 8A illustrates that the sleeve 106 can have two outward tabs 802 having the first length dimension 812 and two other outward tabs 802 having the second length dimension 814. In the variation shown in FIG. 8A, the inward tabs 800 can have the same or substantially equivalent length dimension. In other variations not shown in the figures but contemplated by this disclosure, the inward tabs 800 can have differing length dimensions. Each of the inward tabs 800 can have a gap portion 818 defined along the upper portion 816 of the sleeve frame 120 at the terminal end of the inward tabs 800.

In other embodiments, the second length dimension 814 can be equal to or substantially equivalent to the first length dimension 812.

FIG. 8B illustrates another variation of the securement sleeve 106 comprising inward tabs 800 having a first inward tab 820 and a second inward tab 822. The first inward tab 820 can be separated from the second inward tab 822 by an outward tab 802.

The first inward tab 820 can have a first length dimension 824 and the second inward tab 822 can have a second length dimension 826. The first length dimension 824 can be a longitudinal length of the first inward tab 820. The first length dimension 824 can be measured from the base of the first inward tab 820 to the tip or terminal end of the first inward tab 820. The base of the first inward tab 820 can be the portion of the first inward tab 820 connected to the lower portion 830 of the sleeve frame 120.

The second length dimension 826 can be a longitudinal length of the second inward tab 822. The second length dimension 826 can be measured from the base of the second inward tab 822 to the tip or terminal end of the second inward tab 822. The base of the second inward tab 822 can be the portion of the second inward tab 822 connected to the lower portion 830 of the sleeve frame 120.

The second length dimension 826 can be greater than the first length dimension 824. The difference between the second length dimension 826 and the first length dimension 824 can be between about 0.10 mm and 2.0 mm. The difference between the second length dimension 826 and the first length dimension 824 can be between about 0.01 mm and about 0.10 mm. FIG. 8B illustrates that the securement sleeve 106 can have two inward tabs 800 having the first length dimension 824 and two other inward tabs 800 having the second length dimension 826. In the variation shown in FIG. 8B, the outward tabs 802 can have the same or substantially equivalent length dimension. In other variations not shown in the figures but contemplated by this disclosure, the outward tabs 802 can have differing length dimensions. Each of the inward tabs 800, including the first inward tab 820 and the second inward tab 822, can have a gap portion 818 defined along the upper portion 816 of the sleeve frame 120 at the terminal end of the inward tabs 800.

FIG. 8C illustrates that another variation of the sleeve 106 can have nine total locking tabs 122 with three inward tabs 800 and six outward tabs 802. The locking tabs 122 can be arranged so that each inward tab 800 is adjacent to two outward tabs 802 and each outward tab 802 is adjacent to one inward tab 800 and one other outward tab 802. FIG. 8C also illustrates that the outward tabs 802 can comprise a first outward tab 832 and a second outward tab 834.

The first outward tab 832 can have a first length dimension 836 and the second outward tab 834 can have a second length dimension 838. The first length dimension 836 can be a longitudinal length of the first outward tab 832. The first length dimension 836 can be measured from the base of the first outward tab 832 to the tip or terminal end of the first outward tab 832. The base of the first outward tab 832 can be the portion of the first outward tab 832 connected to the upper portion 816 of the sleeve frame 120.

The second length dimension 838 can be a longitudinal length of the second outward tab 834. The second length dimension 838 can be measured from the base of the second outward tab 834 to the tip or terminal end of the second outward tab 834. The base of the second outward tab 834 can be the portion of the second outward tab 834 connected to the upper portion 816 of the sleeve frame 120.

The second length dimension 838 can be greater than the first length dimension 836. The difference between the second length dimension 838 and the first length dimension 836 can be between about 0.10 mm and 2.0 mm. The difference between the second length dimension 838 and the first length dimension 836 can be between about 0.01 mm and 0.10 mm. FIG. 8C illustrates that the sleeve 106 can have three outward tabs 802 having the first length dimension 836 and three other outward tabs 802 having the second length dimension 838. In the variation shown in FIG. 8C, the inward tabs 800 can have the same or substantially equivalent length dimension. In other variations not shown in the figures but contemplated by this disclosure, the inward tabs 800 can have differing length dimensions. Each of the inward tabs 800 can have a gap portion 818 defined along the upper portion 816 of the sleeve frame 120 at the terminal end of the inward tabs 800.

FIG. 8D illustrates that another variation of the securement sleeve 106 can comprise nine total locking tabs 122 with three inward tabs 800 and six outward tabs 802. In the variation shown in FIG. 8D, the locking tabs 122 can be arranged such that each inward tab 800 is adjacent to two outward tabs 802 and each outward tab 802 is adjacent to one inward tab 800 and one other outward tab 802. FIG. 8D also illustrates that the outward tabs 802 can comprise a first outward tab 840, a second outward tab 842, and a third outward tab 844.

The first outward tab 840 can have a first length dimension 846, the second outward tab 842 can have a second length dimension 848, and the third outward tab 844 can have a third length dimension 850. The first length dimension 846, the second length dimension 848, and the third length dimension 850 can be longitudinal lengths of the first outward tab 840, the second outward tab 842, and the third outward tab 844, respectively.

The first length dimension 846 can be measured from the base of the first outward tab 840 to the tip or terminal end of the first outward tab 840. The base of the first outward tab 840 can be the portion of the first outward tab 840 connected to the upper portion 816 of the sleeve frame 120. The second length dimension 848 can be measured from the base of the second outward tab 842 to the tip or terminal end of the second outward tab 842. The base of the second outward tab 842 can be the portion of the second outward tab 842 connected to the upper portion 816 of the sleeve frame 120.

The third length dimension 850 can be measured from the base of the third outward tab 844 to the tip or terminal end of the third outward tab 844. The base of the third outward tab 844 can be the portion of the third outward tab 844 connected to the upper portion 816 of the sleeve frame 120.

The third length dimension 850 can be greater than the first length dimension 846 but less than the second length dimension 848. The difference between the second length dimension 848 and the first length dimension 846 can be between about 0.10 mm and about 4.0 mm. The difference between the second length dimension 848 and the first length dimension 846 can also be between about 0.01 mm and about 0.10 mm. FIG. 8D illustrates that the securement sleeve 106 can have two outward tabs 802 having the first length dimension 846, another two outward tabs 802 having the second length dimension 848, and yet another two outward tabs 802 having the third length dimension 850. In the variation shown in FIG. 8D, the inward tabs 800 can have the same or substantially equivalent length dimension. In other variations not shown in the figures but contemplated by this disclosure, the inward tabs 800 can have differing length dimensions. Each of the inward tabs 800 can have a gap portion 818 defined along the upper portion 816 of the sleeve frame 120 at the terminal end of the inward tabs 800.

Although not shown in the figures, another variation of the sleeve 106 is contemplated by this disclosure that can have nine total locking tabs 122 with three inward tabs 800 and six outward tabs 802. The locking tabs 122 can be arranged so that each inward tab 800 is adjacent to two outward tabs 802 and each outward tab 802 adjacent to one inward tab 800 and one other outward tab 802. The outward tabs 802 can include a first outward tab, a second outward tab, and a third outward tab.

The first outward tab can have a first length dimension, the second outward tab can have a second length dimension, and the third outward tab can have a third length dimension. The first length dimension, the second length dimension, and the third length dimension can be longitudinal lengths of the first outward tab, the second outward tab, and the third outward tab, respectively.

The first length dimension can be measured from the base of the first outward tab to the tip or terminal end of the first outward tab. The base of the first outward tab can be the portion of the first outward tab connected to the upper portion 816 of the sleeve frame 120. The second length dimension can be measured from the base of the second outward tab to the tip or terminal end of the second outward tab. The base of the second outward tab can be the portion of the second outward tab connected to the upper portion 816 of the sleeve frame 120.

The third length dimension can be measured from the base of the third outward tab to the tip or terminal end of the third outward tab. The base of the third outward tab can be the portion of the third outward tab connected to the upper portion 816 of the sleeve frame 120.

The third length dimension can be greater than the second length dimension and the second length dimension can be greater than the first length dimension. The difference between the second length dimension and the first length dimension can be between about 0.10 mm and 2.0 mm. The difference between the third length dimension and the second length dimension can be between about 0.10 mm and 2.0 mm. The securement sleeve 106 can have two outward tabs 802 having the first length dimension, another two outward tabs 802 having the second length dimension, and two additional outward tabs 802 having the third length dimension. In one variation, the inward tabs 800 can have the same or substantially equivalent length dimension. In other variations, the inward tabs 800 can have differing length dimensions. Each of the inward tabs 800 can have a gap portion 818 defined along the upper portion 816 of the sleeve frame 120 at the terminal end of the inward tabs 800.

Although several variations of the sleeve 106 having different number and arrangement of locking tabs 122 are shown, it should be understood by one of ordinary skill in the art that other variations of the sleeve 106 are contemplated by this disclosure including sleeves 106 having less than eight locking tabs 122 or more than nine locking tabs 122. In addition, it is contemplated by this disclosure that all of the locking tabs 122 of a singular sleeve 106 can have a different length dimension and none of the locking tabs 122 of this singular sleeve 106 can be of the same or equivalent lengths.

FIGS. 9A to 9B illustrate steps of a method for securing a dental prosthesis 102 within an oral cavity of a subject using components of the system 100 disclosed herein. FIG. 9A illustrates that a one-piece implantable abutment 104 comprising an integrated or combined abutment portion 112 and threaded fixation portion 110 can be installed or otherwise implanted within the alveolar bone or alveolar process of the subject. In some embodiments, the abutment portion 112 can be a substantially straight abutment portion. In other embodiments, the abutment portion 112 can be an angled abutment portion 400 (see FIGS. 4A and 4B).

During the installation or implantation step, an insertion cap 600 can be placed over or onto the abutment portion 112 to allow a drive tool 504 to apply torque to the implantable abutment 104 during the implantation procedure. In alternative embodiments, a connector or tool bit disposed at a distal end of the drive tool 504 can engage directly with a projection or cavity/recess defined along an abutment top 114. The insertion cap 600 can be removed from the implantable abutment 104 once the implantable abutment 104 is secured within the oral cavity of the subject.

At least part of the abutment portion 112 of the implantable abutment 104 can protrude out of the gingiva of the subject when the implantable abutment 104 is secured within the alveolar bone or alveolar process of the subject. In some embodiments, the abutment portion 112 and at least part of the threaded fixation portion 110 can protrude out of the gingiva of the subject when the implantable abutment is implanted within the alveolar bone or alveolar process of the subject.

FIG. 9B illustrates that a securement sleeve 106 comprising a plurality of locking tabs 122 can be introduced onto a frustum 118 of the abutment portion 112 of the implantable abutment 104. The securement sleeve 106 can be in a locking configuration 900 when introduced onto the abutment portion 112.

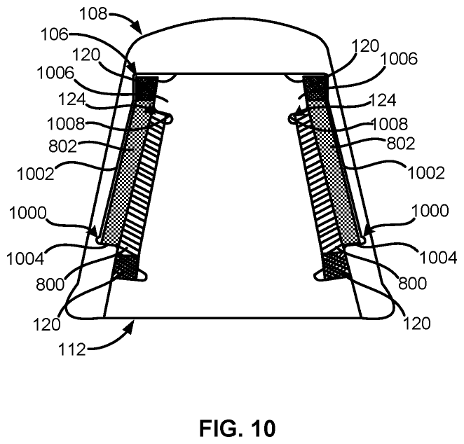

The sleeve 106 can be any of the sleeves 106 shown in FIGS. 2, 3B, and 8A-8D. The sleeve 106 can have locking tabs 122 of differing lengths such as any of the locking tabs 122 depicted in FIGS. 8A-8D. The sleeve 106 can be in the locking configuration 900 when one or more inward tabs 800 project radially inward relative to the sleeve frame 120. The inward tabs 800 can lock against a tab end receiving surface 1008 of an abutment overhang portion 1006 (see FIG. 10) of the abutment portion 112. The bottom edge of the sleeve frame 120 can also push against a rimmed or edge portion of the abutment base 116 to couple or secure the sleeve 106 to the abutment portion 112. FIG. 9B also illustrates that one or more outward tabs 802 can project radially outward relative to the sleeve frame 120 when the sleeve 106 is in the locking configuration 900.

As illustrated in FIG. 9B, a dental prosthesis 102 (e.g., a crown) can be coupled to a coping 108 configured to be placed onto the sleeve 106 configured in the locking configuration 900 (and secured to the abutment portion 112). In some embodiments, the coping 108 can already be adhered or otherwise affixed to the dental prosthesis 102 via luting agents or other type of adhesives. In other embodiments, the coping 108 can first be put on the sleeve 106 and the dental prosthesis 102 can be adhered or affixed to a coping exterior surface when the coping 108 is positioned on the abutment portion 112. As will be discussed in more detail in the following sections, the outward tabs 802 of the securement sleeve 106 can physically push or wedge against a tab receiving surface 1004 of a coping undercut 1000 (see FIG. 10) to lock the coping 108 to the securement sleeve 106. Once the outward tabs 802 have locked the coping 108 to the sleeve 106, the coping 108 (and the dental prosthesis 102 adhered or otherwise affixed to the coping 108) can be prevented from being inadvertently displaced (e.g., vertically displaced) from the abutment portion 112 of the implantable abutment 104.

FIG. 10 illustrates a cross-sectional side view of a variation of a coping 108 covering a sleeve 106 secured to the abutment portion 112 of the implantable abutment 104. As shown in the example embodiment of FIG. 10, the sleeve 106 is in the locking configuration 900 when secured to the abutment portion 112 of the implantable abutment 104.

FIG. 10 illustrates that the coping 108 can comprise a coping undercut 1000 defined along or otherwise set into a coping inner surface 1002. The coping inner surface 1002 can be a tapered underside surface of the coping 108. The coping inner surface 1002 can surround and be in physical contact with an exterior surface of the sleeve 106 including portions of the sleeve frame 120 and the locking tabs 122.

The coping undercut 1000 can be an annular, partial-annular, or disk-shaped groove or indentation extending radially into the coping inner surface 1002. The coping undercut 1000 can be defined along a lower portion or lower half of the coping 108 near a base of the coping 108. The coping undercut 1000 can extend circumferentially around the coping inner surface 1002.

The coping undercut 1000 can comprise a tab receiving surface 1004. In some embodiments, the tab receiving surface 1004 can be a straight or substantially horizontal surface or edge. In other embodiments, the tab receiving surface 1004 can be curved or filleted edge having a radius. In further embodiments, the tab receiving surface 1004 can be a chamfered or angled surface or edge. In certain variations, the tab receiving surface 1004 can be an abraded or friction-inducing surface.

As illustrated in FIG. 10, one or more outward tabs 802 can lock against the coping undercut 1000. The outward tabs 802 of the securement sleeve 106 can lock against the coping undercut 1000. The outward tabs 802 can lock against the coping undercut 1000 when the terminal or distal ends of the outward tabs 802 pushes against or contacts the tab receiving surface 1004 of the coping undercut 1000. The outward tabs 802 can lock against the coping undercut 1000 to prevent the coping 108 from being inadvertently displaced (e.g., longitudinally displaced) from the implantable abutment 104. One benefit of the securement sleeve 106 having locking tabs 122 of differing lengths is to provide tolerance for mistakes committed by the dental practitioner in placing the coping 108 onto the abutment portion 112.

As illustrated in FIG. 10, the abutment portion 112 can comprise an abutment overhang portion 1006 and an abutment undercut 124 adjoining the abutment overhang portion 1006. The abutment overhang portion 1006 can be an overhang or annular or cornice-like structure protruding radially outward relative to a lateral (tapered) surface of the frustum 118. The abutment overhang portion 1006 can be positioned in proximity to the abutment top 114. The abutment undercut 124 can be an annular, partial-annular, or disk-shaped groove or indentation extending radially inward relative to a lateral (tapered) surface of the frustum 118.

The abutment overhang portion 1006 can comprise a tab end receiving surface 1008. The tab end receiving surface 1008 can be an edge or surface defined in proximity to the abutment undercut 124. The tab end receiving surface 1008 can be a chamfered, beveled, pitched, or sloped edge or surface. The tab end receiving surface 1008 can act as a receiving surface for contacting a terminal or distal end of the inward tabs 800 of the securement sleeve 106. The tab end receiving surface 1008 can offer or present a surface aligned with the terminal or distal ends of the inward tabs 800 as the inward tabs 800 curve or bend radially inward relative to the sleeve frame 120.

In other embodiments not shown in the figures, the tab end receiving surface 1008 can be a substantially flat or horizontal edge or surface. In these and other embodiments, the tab end receiving surface 1008 can be an abraded or friction-inducing surface or comprise a friction-inducing coating or surface treatment.

As shown in FIG. 10, a plurality of inward tabs 800 can lock against the tab end receiving surface 1008 when the terminal or distal ends of the inward tabs 800 pushes against or physically contacts the tab end receiving surface 1008 when the securement sleeve 106 is in the locking configuration 900. When the plurality of inward tabs 800 are locked against the tab end receiving surface 1008 of the abutment overhang portion 1006, the securement sleeve 106 can be considered locked onto the abutment portion 112 such that the sleeve 106 does not become inadvertently displaced (e.g., longitudinally displaced) from the abutment portion 112.

The abutment undercut 124 can facilitate the proper locking of the securement sleeve 106 to the abutment portion 112. For example, the extra space provided by the abutment undercut 124 can allow the terminal or distal ends of the inward tabs 800 to contact or push against the tab end receiving surface 1008 without the lateral surface of the frustum 118 deflecting the inward tabs 800 away from the abutment overhang portion 1006. Moreover, the abutment undercut 124 can prevent the lateral surface of the frustum 118 from deflecting or pushing the inward tabs 800 away from the abutment overhang portion 1006 as a result of forces exerted on the subject's dental prosthesis 102, securement sleeve 106, or implantable abutment 104 during normal wear. Another benefit of the securement sleeve 106 having locking tabs 122 of differing lengths is to provide tolerance for mistakes committed by the dental practitioner in placing the securement sleeve 106 onto the abutment portion 112.

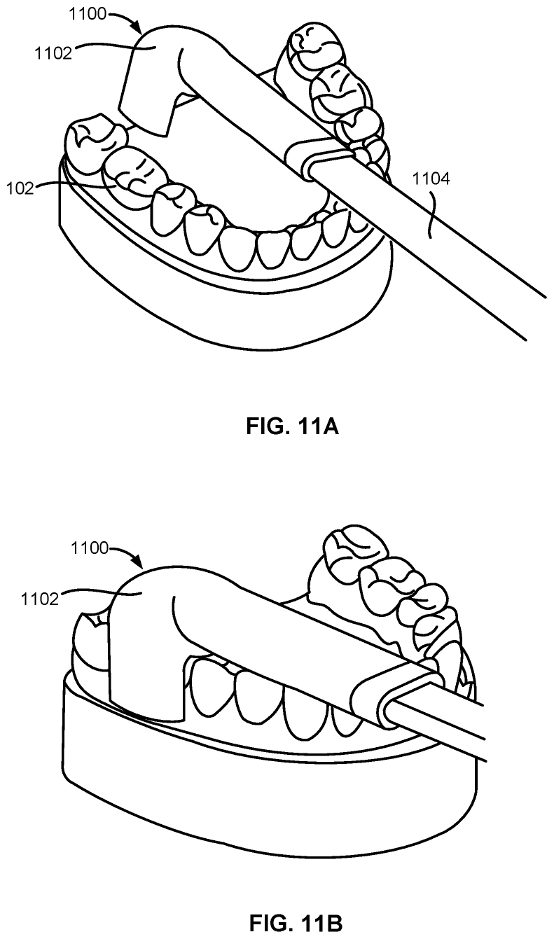

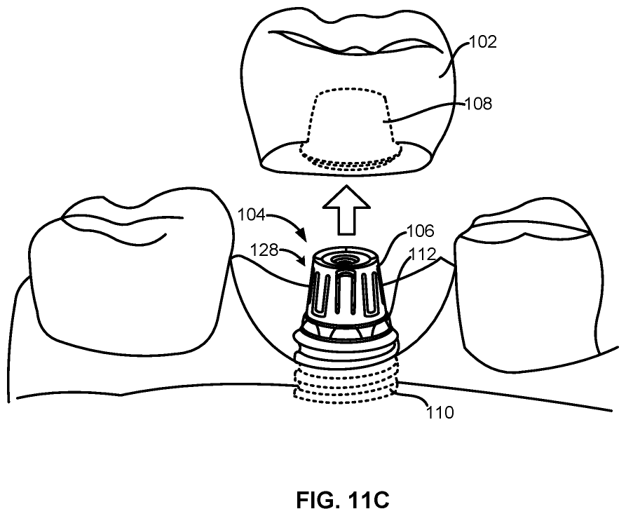

FIGS. 11A to 11C illustrate steps of a method for removing the dental prosthesis 102 from the implantable abutment 104. FIG. 11A illustrates that an actuator unit 1100 can be used to actuate the locking tabs 122 of the securement sleeve 106 underneath the dental prosthesis 102 to change the configuration of the securement sleeve 106 from the locking configuration 900 (see FIG. 9B) to the low-profile configuration 128.

The actuator unit 1100 can be a handheld or portable unit. The actuator unit 1100 can comprise an actuator head 1102 and an actuator handle 1104. The actuator unit 1100 can also comprise or be connected to a power source (not shown in the figures).

FIG. 11B illustrates that the actuator head 1102 of the actuator unit 1100 can be placed over or on top of the dental prosthesis 102. The actuator unit 1100 can comprise an inductive heating assembly comprising a controller-like variable output oscillator circuit, a conductor, and one or more coils set apart in apposition and at a distance from one another. The controller-like variable output oscillator circuit can be coupled to the conductor and the coils. The distance or gap between the coils can define a receiving channel which can be sized to be positioned over the dental prosthesis 102 (e.g., the crown) shown in FIGS. 11A and 11B. When the entire stack comprising the dental prosthesis 102, the coping 108, the securement sleeve 106, and the abutment portion 112 of the implantable abutment 104 are positioned within the receiving channel of the actuator head 1102, the controller-like variable output oscillator circuit can send an alternating current through the conductor to the coils to generate an alternating magnetic field between the coils. The alternating magnetic field can cause eddy currents to form in at least part of the coping 108, the securement sleeve 106, the abutment portion 112, or a combination thereof. The eddy currents can cause at least part of the coping 108, the securement sleeve 106, the abutment portion 112, or a combination thereof to heat up, thereby activating the shape memory material of the locking tabs 122 to initiate their shape change and cause the sleeve 106 to actuate into the low-profile configuration 128 (see FIG. 11C).

The frequency of the alternating current and the magnetic field can be set between about 1 kHz and about 1 MHz, depending on the size and configuration of the locking tabs 122 and the activation time. In some embodiments, the power consumption can range between about 1 W to about 150 W. The induction heating assembly can be the induction heating assembly described in U.S. Pat. No. 9,168,111, which is herein incorporated by reference in its entirety. The actuator head 1102 can also comprise a disposable or one-time use tip for covering or protecting the actuator head 1102.

As illustrated in FIG. 11C, once the securement sleeve 106 is actuated into the low-profile configuration 128, the coping 108 coupled to the dental prosthesis 102 (e.g., the crown) can be uncoupled or lifted off of the sleeve 106 and the abutment portion 112.

The securement sleeve 106 can be fabricated from or made in part of a shape memory material (e.g., Nitinol). The sleeve 106 in the tapered frustoconical configuration can be heat treated when formed into the low-profile configuration 128 to retain the shape memory of the low-profile configuration 128 with all of the locking tabs 122 collapsed or flush with the lateral surface of the sleeve frame 120. In some embodiments, the sleeve 106 can then be allowed to cool and manually formed into the locking configuration 900.

As previously shown in FIG. 9B, the sleeve 106 can be locked onto the abutment portion 112 of the implantable abutment 104 when the sleeve 106 is in the locking configuration 900. A coping 108 (with or without the dental prosthesis 102 attached) can then be placed on top of or over the sleeve 106 secured to the abutment portion 112 to lock the coping 108 to the abutment portion 112.

When the time comes for a dental professional to remove the dental prosthesis 102 from the abutment portion 112, the sleeve 106 can be heated beyond a threshold temperature (e.g., the shape memory transformation temperature of the sleeve 106) using the actuator unit 1100 and the sleeve 106 can once again return to its low-profile configuration 128 to allow the coping 108 (and the dental prosthesis 102 attached to the coping 108) to be lifted off the sleeve 106 and the abutment portion 112. In these embodiments, the sleeve 106 can return to the locking configuration 900 by actively cooling the sleeve 106 or when the temperature of the sleeve 106 falls below a threshold temperature.

A number of embodiments have been described. Nevertheless, it will be understood by one of ordinary skill in the art that various modifications may be made without departing from the spirit and scope of the embodiments. In addition, the flowcharts or logic flows depicted in the figures do not require the particular order shown, or sequential order, to achieve desirable results. In addition, other steps or operations may be provided, or steps or operations may be eliminated, from the described flows, and other components may be added to, or removed from, the described systems. Accordingly, other embodiments are within the scope of the following claims.

Each of the individual variations or embodiments described and illustrated herein has discrete components and features which may be readily separated from or combined with the features of any of the other variations or embodiments. Modifications may be made to adapt a particular situation, material, composition of matter, process, process act(s) or step(s) to the objective(s), spirit or scope of the present invention.

Methods recited herein may be carried out in any order of the recited events that is logically possible, as well as the recited order of events. Moreover, additional steps or operations may be provided or steps or operations may be eliminated to achieve the desired result.

Furthermore, where a range of values is provided, every intervening value between the upper and lower limit of that range and any other stated or intervening value in that stated range is encompassed within the invention. Also, any optional feature of the inventive variations described may be set forth and claimed independently, or in combination with any one or more of the features described herein.

All existing subject matter mentioned herein (e.g., publications, patents, and patent applications) is incorporated by reference herein in its entirety except insofar as the subject matter may conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise, all technical and scientific terms used herein have the same meaning as commonly understood by one of ordinary skill in the art to which this invention belongs.

This disclosure is not intended to be limited to the scope of the particular forms set forth, but is intended to cover alternatives, modifications, and equivalents of the variations or embodiments described herein. Further, the scope of the disclosure fully encompasses other variations or embodiments that may become obvious to those skilled in the art in view of this disclosure.

It will be understood by one of ordinary skill in the art that the various methods disclosed herein may be embodied in a non-transitory readable medium, machine-readable medium, and/or a machine accessible medium comprising instructions compatible, readable, and/or executable by a processor or server processor of a machine, device, or computing device. The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

We claim:

1. A system for securing a dental prosthesis within an oral cavity of a subject, comprising:
an implantable abutment comprising a threaded fixation portion and an abutment portion, wherein at least part of the threaded fixation portion is configured to be implanted within the alveolar bone of the subject, wherein at least part of the abutment portion is configured to protrude beyond the gingiva of the subject;
a sleeve comprising a sleeve frame and a plurality of locking tabs, wherein the sleeve is configured to fit over at least a portion of the abutment portion, and wherein a subset of the plurality of locking tabs are configured to project radially inward relative to the sleeve frame to secure the sleeve to the abutment portion; and
a coping comprising a coping exterior surface configured to be adhered to the dental prosthesis, wherein the coping is configured to be placed over the sleeve when the sleeve is secured to the abutment portion, and wherein another subset of the plurality of locking tabs are configured to project radially outward relative to the sleeve frame to secure the coping to the sleeve.

2. The system of claim 1, wherein the threaded fixation portion is defined by an exterior tubular profile and wherein the abutment portion is set within the exterior tubular profile.

3. The system of claim 1, wherein the abutment portion is angled with respect to a longitudinal axis of the threaded fixation portion.

4. The system of claim 3, wherein the abutment portion is angled with respect to the longitudinal axis of the threaded fixation portion at an angle of about 13 degrees.

5. The system of claim 3, wherein the abutment portion is angled with respect to the longitudinal axis of the threaded fixation portion at an angle of about 26 degrees.

6. The system of claim 1, further comprising an insertion cap configured to be placed over the abutment portion and wherein the insertion cap further comprises a tool coupling feature for detachably engaging with a rotatable drive tool used to apply torque to the implantable abutment.

7. The system of claim 6, wherein the insertion cap detachably engages with at least a portion of the threaded fixation portion.

8. The system of claim 1, wherein at least part of the threaded fixation portion and the abutment portion protrude out of the gingiva of the subject when the implantable abutment is implanted within the alveolar bone of the subject.

9. The system of claim 1, wherein the abutment portion is directly connected to the threaded fixation portion without an intervening fastener.

10. The system of claim 1, wherein the dental prosthesis is at least part of a dental crown, a bridge, a partial overdenture, or a complete overdenture.

11. A method of securing a dental prosthesis within an oral cavity of a subject, comprising:
securing an implantable abutment within an oral cavity of a subject, wherein the implantable abutment comprises a threaded fixation portion and an abutment portion, wherein at least part of the threaded fixation portion is implanted within the alveolar bone of the subject, and wherein at least part of the abutment portion extends beyond the gingiva of the subject;
introducing a sleeve comprising a plurality of locking tabs on to a part of the abutment portion, wherein a subset of the plurality of locking tabs project radially inward relative to the sleeve frame to secure the sleeve to the abutment portion; and
introducing a coping comprising a coping surface configured to be adhered to the dental prosthesis on to a part of the sleeve when the sleeve is secured to the abutment portion.

12. The method of claim 11, wherein the threaded fixation portion is defined by an exterior tubular profile and wherein the abutment portion is set within the exterior tubular profile.

13. The method of claim 11, wherein the abutment portion is angled with respect to a longitudinal axis of the threaded fixation portion.

14. The method of claim 13, wherein the abutment portion is angled with respect to the longitudinal axis of the threaded fixation portion at an angle of about 13 degrees.

15. The method of claim 13, wherein the abutment portion is angled with respect to the longitudinal axis of the threaded fixation portion at an angle of about 26 degrees.

16. The method of claim 11, further comprising capping the abutment portion with an insertion cap, and applying torque to the implantable abutment using a rotatable drive tool configured to detachably engage with a tool coupling feature of the insertion cap.

17. The method of claim 16, wherein the insertion cap detachably engages with at least a portion of the threaded fixation portion.

18. The method of claim 11, wherein at least part of the threaded fixation portion and the abutment portion protrude out of the gingiva of the subject when the implantable abutment is secured within the oral cavity of the subject.

19. The method of claim 11, wherein the abutment portion is directly connected to the threaded fixation portion without an intervening fastener.

20. The method of claim 11, wherein the dental prosthesis is at least part of a dental crown, a bridge, a partial overdenture, or a complete overdenture.
